(19) United States
(12) Patent Application Publication
(10) Pub. No.: US 2015/0056538 A1
(43) Pub. Date: Feb. 26, 2015

(54) Device for protecting crops using hologram of natural enemy eyes and method for fabricating the same

(71) Applicant: BIO DEFENSE, Seoul (KR)

(72) Inventor: Sung Sub HA, Yongin-si (KR)

(73) Assignee: BIO DEFENSE, Seoul (KR)

(21) Appl. No.: 14/012,482

(22) Filed: Aug. 28, 2013

(30) Foreign Application Priority Data
Aug. 23, 2013 (KR) 1020130100715

(51) Int. Cl. G03H 1/02

(52) U.S. Cl. CPC G03H 1/02
USPC 430/2

(57) ABSTRACT

Disclosed are a device for protecting crops from wildlife, comprising an optical base film on both sides of which fluorescent holograms of natural enemies with both eyes and optionally claws or talons are laser printed while a composition containing a phosphorescent material and a repellent is applied to both eyes, and optionally to the claws or talons, and a method for fabricating the same. Oils and extracts from herbs are used selectively as ingredients in the repellent depending on repelling targets, that is, mammals, rodents and birds. In addition, the use of phosphorescent material exerts a repellent effect on nocturnal animals. Thus, the device exhibits high durability and can be used for protection from wildlife damage in various targets.

### BACKGROUND OF THE INVENTION

1. Field of the Invention

The present invention relates to a device for protecting wildlife crop damage using holographic eyes of natural enemies of crop-damaging animals, and a method for fabricating the same. More particularly, the present invention relates to a device for protecting wildlife crop damage by repelling wild animals from crop farms or fields, fabricated by laser printing a hologram of a face figure with both eyes, or a whole body figure with both eyes, legs and claws or talons of a natural enemy to crop-damaging animals on each side of a base film which adjusts the intensity of light by reflection or transmission; and applying a composition comprised of a phosphorescent material, an epoxy resin and a repellent to the eyes, and optionally to the claws or talons, of the holographic figure.

2. Description of the Related Art

Wildlife crop damage is a worldwide problem, caused by a broad spectrum of animals, although differing from one country to another, including, inter alia in Korea, mammals and rodents such as various wild boars, deer, raccoons, badgers, rabbits, Eurasian red squirrels, Chinese water deer, rats, moles, beavers, etc., and birds such as magpies, crows, common cuckoos, ducks, etc.

Over the last ten years a great increase has been brought about in the population of wild animals in South Korea thanks to the Korean Wildlife Refuge Act. In addition, the increase in the population of wild animals damaging crops is promoted with the relative reduction of natural enemies against them. At present, annual wildlife crop damage is estimated to account for up to millions of dollars, with a steady increase each year. Disruption of the food chain has often led to, for example, wild boars appearing in the city, with attacks on people.

Paddy fields and farms are disrupted predominantly by mammalian wild animals such as wild boars, deer, etc., while birds are frequent invaders of corn fields, orchards, and gardens. In South Korea, a great amount of damage is caused to ginseng farms or soybean fields by pheasants.

Thus far, protection against wildlife crop damage has relied mainly on mechanical devices and/or chemical methods alone, or in combination, i.e., devices or agents for entrapping or repelling animals. For example, Korean Patent No. 10-0432706 discloses a device for repelling animals and birds, comprising a repellent, and a reflection plate with rotation which causes an optical illusion. Korean Patent Publication No. 10-2012-0069001 introduces a device of driving birds and wild animals away using sound or light.

Reference may be made to Korean Patent No. 10-1167069 for a wild-animal repellent formulation, to Korean Patent No. 10-1192980 for a wild-animal repellent composition comprising an emulsifier, and to Korean Patent No. 10-1181454 for a liquid-type composition for repelling wild animals. Also, other wild-animal repellent compositions are disclosed in Korean Patent Nos. 10-1152343 and 10-0984217 while solid-type and gel-type bird repellent compositions are described in Korean Patent Publication No. 10-2010-0120849 and Korean Patent No. 10-0798290, respectively. Korean Patent Publication No. 10-2011-0057041 introduces a film-type, reflective structure for protecting farm produce from wild birds and mammals in which a transparent polyethylene film in the shape of a natural enemy is overlaid with a reflective layer composed of an aluminum metal foil and underlaid with a photoluminescent material.

This device is advantageous to repel animals at night because it takes a whole body figure of a natural enemy with a photoluminescent material deposited on one side thereof, but is observed to have almost no repellent effects daytime. Further, the photoluminescent material deposited across the whole body figure of a natural enemy is likely to degrade under daytime UV light, and thus becomes poor in durability, leading to a decrease in repelling effect with time. Therefore, the device exhibits little protective effect on crops from wildlife after a certain period of time.

Korean Patent No. 10-1192980, issued to the present inventor, discloses a repellent composition against wildlife. This repellent composition is effective for some birds and rodents, such as doves, wild boars, rats, etc., but not for general wildlife.

### SUMMARY OF THE INVENTION

It is therefore an object to provide a device for repelling wildlife, taking a face figure or a whole body figure of a natural enemy in which a phosphorescent material blended with a binder and a repellent is applied to eyes and/or claws or talons, optionally with a fluorescent material partially applied to the figure so as to repel diurnal crop-damaging animals and a method for protecting crops using the same (a method for fabricating the same.)

To accomplish the above object, the present invention provides a method for fabricating a wildlife-repelling device, comprising providing a synthetic resin-based, optical base film reflective of light; laser printing a hologram of a face figure with both eyes, or a whole body figure with both eyes, legs and claws or talons of a natural enemy to crop-damaging animals on each side of the base film; applying a composition comprised of a phosphorescent material, an epoxy resin and a repellent to the eyes, and optionally to the claws or talons, of the holographic figure, followed by drying the composition. Optionally, the method may further comprise applying a fluorescent material around the eyes of the figure at a width of 1˜10 mm after the application of the composition containing the phosphorescent material.

Also, the present invention provides a composition for repelling a broad spectrum of wild animals, configured to be applied to a hologram of a natural enemy of such animals, with high efficiency.

Capable of repelling a broad spectrum of wildlife including mammals, birds and rodents for a long period of time, the device of the preset invention is very effective for protecting crops from wildlife damage.

### BRIEF DESCRIPTION OF THE DRAWINGS

The above and other objects, features and advantages of the present invention will be more clearly understood from the following detailed description taken in conjunction with the accompanying drawings, in which:

FIGS. 1A to 1D are photographs of products, called “Enemy Eyes,” showing face figures according to preferred embodiments of the present invention.

### DESCRIPTION OF THE PREFERRED EMBODIMENTS

Reference now should be made to the drawings, in which the same reference numerals are used throughout the different drawings to designate the same or similar components.

FIGS. 1A and 1B are representations of holographic face figures of enemy animals printed on both sides of individual base films which reflect light, in which the sides may be provided with the same or different face figures, e.g., a tiger alone on both sides, or a tiger on one side and a wolf on the other side, so as to repel mammals or rodents.

In another embodiment of the present invention, the hologram may be a representation of an animal figure containing front paws with claws as well as a face with both eyes.

FIGS. 1C and 1D are representations of holographic face figures of enemy animals printed on both sides of individual base films which reflect light, in which the sides may be provided with the same or different face figures, e.g., an eagle alone on both sides, or an eagle on one side and a wolf on the other side, so as to repel birds.

In another embodiment of the present invention, the hologram may be a representation of an animal figure containing the feet with talons of, for example, an eagle or an owl, as well as a face with both eyes.

The device, named “Enemy Eyes,” in which a composition comprising a phosphorescent material and a repellent is applied to both eyes of the natural enemy figure, as shown in FIGS. 1A to 1D, can be used for protecting not only various crops including rice, barley, vegetables, apples, pears, grapes, blueberries, oranges, and ginseng, but also has applications in various fields including highways and roads to avoid road kills, national parks, buildings, green houses, power facilities, cultural asset facilities, telecommunications base stations, and food plants.

The present invention addresses holographic figures of natural enemies, featuring the eyes and claws or talons coated with a composition comprising a phosphorescent material and a repellent, whereby a great effect can be brought about in the prohibition of unwelcome wildlife access to protected areas. Holograms of tigers, wolves, eagles, and owls are illustrated above with reference to FIGS. 1A˜1D.

So long as it can adjust light intensity by reflection or transmission, any optical film may be used as the base film. Preferable is a base film on which a hologram is printed. In addition, the base film is preferably thermally stable and resistant to abrasion and corrosion. For use in the present invention, the base film is formed of a transparent synthetic resin, preferably of polyethylene terephthalate. In another preferred embodiment, the base film ranges in thickness from 100 to 300 μm. The optical film is prepared with a fluorescent material which can reflect or transmit light. The fluorescent material is contained preferably in an amount of from 0.001 to 0.1 weight %, based on the total weight of the base film.

Turning to the hologram on the base film, it is preferably graphed using a conventional laser printing technique. The laser-printed hologram of a natural enemy can protect crops from wild animals since it itself is a threat to them. Luminescence from phosphorescent-coated eyes and claws or talons of the natural enemy hologram threatens nocturnal animals, thus further deterring wildlife's invasion.

For use as a luminescent material in the present invention, a fluorescent or phosphorescent material which can control the intensity of light from a white light source by reflection or transmission is used. The fluorescent material may be selected from among a coumarin derivative (e.g., brand name C545T), a quinacridone derivative (e.g, brand name DMQA), and an aminoanthracene derivative (e.g., brand name TTPA). In addition, the phosphorescent material to repel nocturnal animals may be a pyridine iridium derivative (brand name Firfic). A UV-curable unsaturated compound may increase the strength and durability of the luminescent material. A fluorene derivative is suitable as the UV-curable unsaturated compound and may be used in an amount of from 0.001 to 0.1 weight %, based on the total weight of the composition to be applied to the eyes or the craws or talons. In this regard, the UV-curable unsaturated compound, together with an epoxy resin, contributes to adhesiveness to the base film and the surface strength of the film.

In addition to the fluorescent material, a phosphorescent material may be used as a luminescent material to deter nocturnal animals. Preferably, the fluorescent or phosphorescent material is used in a mixture of an epoxy resin. For use in the present invention, the epoxy resin is preferably a bromine (Br)-substituted resin with a high reflective index. For example, an epoxy resin prepared by mixing tetrabromo bisphenol A or acrylic acid-grafted tetrabromobisphenol A with suitable amounts of styrene and divinylbenzene may be preferable.

In accordance with the present invention, the base film is coated with a composition comprising the fluorescent material, the UV-curable resin and the epoxy resin, so that it exhibits high luminance and scratch resistance with the fluorescent material firmly adhering thereto. In addition, the base film of the present invention effectively functions to collect, diffuse, transmit, refract, or reflect light daytime. The phosphorescent material in the base film absorbs radiation in blue or ultraviolet regions and emits radiation in the green region. Thus, the phosphorescent material is resistant to thermal degradation during the daytime, increasing the stability and durability of the base film.

In detail, the luminescent material of the present invention preferably absorbs radiation in the wavelength range of 200 to 400 nm and emits radiation in the wavelength range of 520 to 600 nm. Thus, in order to effectively deter wild animals, a phosphorescent material that can emit energy in the green region must be selected.

In accordance with the present invention, the epoxy resin and the repellent that is described below are formulated at a weight ratio of 10:50:5.

In one preferred embodiment of the present invention, the repellent is a mixture of oils to which wild animals are adverse. At least one of garlic oil, thyme oil and peppermint oil is preferably contained in the wild animal repellent according to the experiment of the invention.

In addition, the repellent may further contain a Chinese bellflower extract and/or a green tea extract. The herb extract may be obtained with hot water or alcohol. Preservative phenoxy ethanol, an alcohol, and a surfactant may be used as additives in the repellent of the present invention. Most preferable is the wild animal repellent that has a composition given in Table 1, below.

TABLE 1
Formulation of Repellent for Mammals and Rodents (Unit: wt (%))

| Ingredient | Ratio | [symbol] |
|---|---|---|
| Garlic oil | 1.00 | Oil phase |
| Thyme oil | 0.02 | Oil phase |
| Peppermint oil | 0.05 | Oil phase |
| Chinese Bellflower extract | 0.50 | Liquid phase |
| Green tea extract | 0.10 | Liquid phase |
| Sum | 1.67 | |
| Phenoxyethanol (preservative) | 0.50 | |
| Alcohol | 5.25 | |
| Surfactant (Tween-20) | 3.50 | |
| Sum | 9.25 | |
| Pure Water | 89.08 | |

From the ingredients, a wild-animal repellent is prepared as follows. The surfactant Tween 20 is added to an alcohol, and stirred for 20 min. Then, the solution is mixed with the preservative phenoxyethanol by vigorously mixing for 10 min, followed by feeding the main repellent ingredients at 70° C. or less while stirring. Finally, pure water is added in a balance amount, and stirred for 10 min.

For a bird repellent, an oil is also used as a main ingredient. It is at least one selected from among capsicum oil and cinnamon oil while a green tea extract participates in the repellent as well (Table 2).

TABLE 2
Formulation of Repellent for Birds (Unit: wt (%))

| Ingredient | Ratio | [symbol] |
|---|---|---|
| Capsicum | 0.50 | Oil phase |
| Cinnamon | 0.10 | Oil phase |
| Green tea extract | 0.10 | Liquid phase |
| Sum | 0.70 | |
| Phenoxyethanol (preservative) | 0.50 | |
| Alcohol | 5.25 | |
| Surfactant (Tween-20) | 3.50 | |
| Sum | 9.25 | |
| Pure Water | 90.05 | |

From the ingredients, a wild-bird repellent is prepared as follows. The surfactant is added to an alcohol, and stirred for 20 min. Then, the solution is mixed with the preservative phenoxyethanol by vigorously mixing for 10 min, followed by feeding the main repellent ingredients capsicum, cinnamon oil, and a green tea extract in the order while stirring at 70° C. or less in order not to evaporate the alcohol. Finally, pure water is added in a balance amount, and stirred for 10 min.

The wild-animal repellent may be used alone at a height of 50˜100 cm, corresponding to the trunk height of the trees, with regular intervals of distance in regions where wild animals frequently appear.

However, where the repellent prepared as described above is applied, in mixture with an epoxy resin and a phosphorescent material, to both eyes and optionally claws or talons of the hologram of a natural enemy, it can exert a triple repellent effect, on wildlife including mammals, rodents and birds, in synergy with the holographic figure of the natural enemy and the phosphorescent light from the mimicking eyes and claws or talons. In addition to the threatening feeling attributed to the reflective luminance from a fluorescent hologram of a natural enemy, a threat from the holographic eyes and claws or talons coated with the epoxy resin composition containing a phosphorescent material and the repellent creates a synergistic repellent effect on wildlife.

Research results of the present inventor showed that the repellent applied to the holographic eyes and claws exhibits a higher repellent effect on mammals or rodents, which have a good sense of smell, while birds were observed to be more repelled by the fluorescent reflective light from the holographic figure of a natural enemy and the phosphorescent light from the holographic eyes and talons because of their strong vision. According to one embodiment of the present invention, efficient repellent effects on most birds, generally strong in sight, were obtained by the fluorescent reflective light from the base film in the daytime and by the phosphorescent reflective light from the holographic eyes and talons at night.

In addition, another research result of the present invention revealed that more effective repellence was obtained against wild mammals when a phosphorescent material emitting green luminance was applied to the eyes and claws and against birds when a phosphorescent emitting yellow luminance was applied to the eyes and talons. In the present invention, a fluorescent material may be applied in the width of 1˜10 nm around the eyes coated with the phosphorescent material.

The device with a natural enemy hologram printed thereon, that is, “Enemy Eyes” is not particularly limited in dimensions. However, a maximum repellent effect was observed when the device with dimensions of 95 mm×65 mm or 120 mm×80 mm was used with a coverage of 9.9 m²˜16.5 m². The repellents formulated as given in Tables 1 and 2 were found to last for 6 months from their preparation.

A better understanding of the present invention may be obtained through the following examples which are set forth to illustrate, but are not to be construed as limiting the present invention.

### Test Example 1

### Test of the Device for Repellent Effect on Birds

The device in which the phosphorescent material and the repellent composition of the present invention was applied to the eyes of eagle and owl holograms printed on respective sides of a base film was tested for repellent effects on doves with 24 h-monitoring under a video camera. They were observed for behavioral abnormality and measured for food uptake.

Results of the food uptake measured in 10 doves of each of the test group and the control group are summarized in Table 3, below. Doves in each group were placed for 7 days in respective spaces of 33 m² with 3 products of the present invention (Enemy Eyes) set on trees (using a string) in each space.

As is understood from the data of Table 1, the animals in the test group showed a significant decrease in food uptake even from day 1 after exposure to “Enemy Eyes”.

TABLE 3
Effect of Enemy Eyes on Food Uptake of Birds (unit: kg)

| Group | Day 1 | Day 2 | Day 3 | Day 4 | Day 5 | Day 6 | Day 7 |
|---|---|---|---|---|---|---|---|
| Test | 20.1 | 10.2 | 5.3 | 0 | 0 | Test | Test |
| | | | | | | quitted | quitted |
| Control | 50 | 49.5 | 49.7 | 50.1 | 50.2 | 49.9 | 50 |

The video monitoring showed that doves in the test group shook their heads, rubbed their beaks quickly, and showed piloerection from day 1.

### Test Example 2

### Test of the Device for Repellent Effect on Mammals

Wild boars were divided into two groups of 10: test and control groups. The phosphorescent material and the repellent composition of the present invention was applied to the eyes of tiger and wolf holograms printed on respective sides of a base film in the same manner as in Example 1. Each cage had a space of 50 m² with 5 sets of Enemy Eyes placed at regular spaces on the gate and wall thereof.

Test results are summarized in Table 4, below. As shown, wild boars in the test group showed a significant decrease in food uptake even from day 1, which became more severe with time, even to such an extent that the test was discontinued on day 4. As monitored in the video tape, wild boars in the test group shook their heads, made great noise and wiped themselves against pillars from day 1, with piloerection on the head.

TABLE 4
Effect of Enemy Eyes on Food Uptake of Mammals (unit: kg)

| Group | Day 1 | Day 2 | Day 3 | Day 4 | Day 5 | Day 6 | Day 7 |
|---|---|---|---|---|---|---|---|
| Test | 20.4 | 10.2 | 5.3 | Test | Test | Test | Test |
| | | | | quitted | quitted | quitted | quitted |
| Control | 51.2 | 102.3 | 150.4 | 201.1 | 250.2 | 301.2 | 351.8 |

### INDUSTRIAL APPLICABILITY

As described hitherto, the product “Enemy Eyes” according to the present invention utilized the reflective light from the fluorescent material applied to the base film and the light from the phosphorescent material applied to the eyes of the hologram on the base film to repel birds and mammals at night time as well as in the day time, with high efficiency. In addition, a synergistic repellent effect can be obtained by the repellent applied to the eyes. The epoxy resin and the UV-curable compound ensure the attachment of the repellent and the luminescent materials to the eyes and claws or talons of the hologram on the base film, thereby bringing about an improvement in scratch resistance, thermal stability and corrosion resistance, lasting the device for 6 months or longer. Further, the phosphorescent material shows useful repellent effects on nocturnal animals. Therefore, the present invention utilizing a natural enemy hologram with luminescent materials applied to the eyes and claws or talons can be applied to the prevention of wildlife damage to constructions, power plants, aircrafts, and cultural assets, as well as crops.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for fabricating a crop-protecting device, comprising:
providing a synthetic resin-based, optical base film reflective of light;
laser printing a hologram of a face figure with both eyes, or a whole body figure with both eyes, legs and claws or talons of a natural enemy on each side of the base film;
applying a composition comprised of a phosphorescent material, an epoxy resin and a repellent to the eyes, and optionally to the claws or talons, of the holographic figure, followed by drying the composition.

2. The method of claim 1, wherein the synthetic optical base film contains a fluorescent material selected from among a coumarin derivative, a quinacridone derivative, and an aminoanthracene derivative (e.g., brand name TTPA).

3. The method of claim 1, wherein the phosphorescent material is contained in an amount of 0.001˜0.1 wt % based on the total weight of the base film.

4. The method of claim 1, wherein the phosphorescent material is applied to both eyes or the claws or talons and is a pyridine iridium derivative.

5. The method of claim 2, wherein the synthetic optical base film further containing a UV-curable unsaturated compound in an amount of 0.001˜0.1 wt %.

6. A device for protecting crops, fabricated by the method of claim 1, comprising an optical base film which represents a hologram of a natural enemy on each of its sides and reflects light from each of the sides.

7. The device of claim 6, wherein the natural enemy on one side is the same as or different from that on the other side.

8. The device of claim 7, wherein the composition applied to the eyes or claws or talons of the natural enemy hologram contains a phosphorescent material, an epoxy resin and a repellent at a weight ratio of 10:50:5.

9. The device of claim 8, wherein the device is designed to repel wild mammals and rodents and the composition contains a garlic oil, a thyme oil, a peppermint oil, a Chinese bellflower extract, a green tea extract, phenoxy ethanol as a preservative, an alcohol, and Tween-20 as a surfactant.

10. The device of claim 10, wherein the device is designed to repel birds and the composition contains a capsicum oil, a cinnamon oil, a green tea extract, phenoxy ethanol as a preservative, an alcohol, and a surfactant as Tween-20.

11. The device of claim 8, wherein the device is designed to repel wild mammals or rodents and the composition contains a phosphorescent material emitting light in a green wavelength region.

12. The device of claim 8, wherein the device is designed to repel birds and the composition contains a phosphorescent material emitting light in a yellow wavelength region.

13. The device of claim 12, wherein the composition is applied to the eyes and the claws or talons of the natural enemy hologram and a fluorescent material is applied at a width of 1˜10 mm around the eyes, whereby an improvement can be brought about in repellent effect.

14. The device of claim 9, wherein the composition is applied to the eyes and the claws or talons of the natural enemy hologram and a fluorescent material is applied at a width of 1˜10 mm around the eyes, whereby an improvement can be brought about in repellent effect.
